(19) United States
(12) Patent Application Publication
(10) Pub. No.: US 2017/0154077 A1
(43) Pub. Date: Jun. 1, 2017

(54) METHOD FOR COMMENT TAG EXTRACTION AND ELECTRONIC DEVICE

(71) Applicants: LE HOLDINGS (BEIJING) CO., LTD., Beijing (CN); LE SHI INTERNET INFORMATION & TECHNOLOGY CORP. BEIJING, Beijing (CN)

(72) Inventor: Chaoming KANG, Beijing (CN)

(21) Appl. No.: 15/249,677

(22) Filed: Aug. 29, 2016

Related U.S. Application Data
(63) Continuation of application No. PCT/CN2016/089277, filed on Jul. 7, 2016.

(30) Foreign Application Priority Data
Dec. 1, 2015 (CN) 201510866792.5

(51) Int. Cl. G06F 17/30; G06F 17/27; G06F 7/20

(52) U.S. Cl. CPC G06F 17/30489; G06F 7/20; G06F 17/2775; G06F 17/30528

(57) ABSTRACT

The present disclosure discloses a method for comment tag extraction and device. The method comprises: performing binary group extraction on each comment corresponding to a current to-be-processed object, combining the extracted binary group into a first set; determining words of which TF-IDF is greater than a first preset threshold value, and combining the determined words into a second set; processing the first set and the second set and generating a third set; determining words of which a theme weight value is greater than a second preset threshold value, and combining the determined words of which the theme weight value is greater than the second preset threshold value into a fourth set; solving a union set of the third set and the fourth set to obtain a fifth set; and performing duplication removal on words in the fifth set, and determining the residual words as comment tags of the current to-be-processed object.

### CROSS-REFERENCE TO RELATED APPLICATIONS

The present application is a continuation of International Application No. PCT/CN2016/089277, filed Jul. 7, 2016, which is based upon and claims priority to Chinese Patent Application No. 201510866792.5, filed Dec. 1, 2015, and the entire contents of all of which are incorporated herein by reference.

### FIELD OF TECHNOLOGY

The present disclosure generally relates to the technical field of tag extraction and, in particular, to a method for comment tag extraction and electronic device.

### BACKGROUND

Thousands of user comments always accompany an object (such as a product, a commercial tenant, a song and a film). How to extract essential information capable of describing the object from redundant comment information to serve as comment tags is one of the hot issues researched at present. Taking a song as an example, if essential information capable of reflecting characteristics of the song can be acquired to serve as tags thereof by processing related comments of the song, intuitive understanding of users on the characteristics of the song is facilitated.

At present, comment tag extraction is mainly realized through the following two schemes:

first: searching comments posted by the users by virtue of manual labor, putting the comments together and extracting certain words of the comments to serve as comment tags of the object. The comment tag extraction scheme is high in time consumption and needs to occupy lots of manpower resources. Moreover, because manual word screening generally has high subjectivity, the extracted comment tags often difficulty reflect the characteristics of the object in the most objective form, and the accuracy of the extracted comment tags is low;

second: directly extracting the comment tags in a text label extraction manner. Specifically, words in each comment are extracted based on word characteristics and template to determine comment tags, which correspond to the object; or words are screened from each comment based on word appearing frequency to serve as comment tags of the object.

Although extraction of comment tags can be automatically completed in the second comment tag extraction scheme above, and compared with the first comment tag extraction scheme, lots of manpower resources and processing time can be saved, relevance between the extracted tags and each comment is low because mutual relation among the comments is neglected by the extraction method, and finally, the accuracy of the extracted comment tags is still low.

### SUMMARY

The present disclosure discloses a method for comment tag extraction and a device for comment tag extraction, for solving the problem that the accuracy of comment tags extracted by the existing comment tag extraction scheme is low.

To solve the problem above, an embodiment of the present disclosure discloses a method for comment tag extraction, including: performing binary group extraction on each comment corresponding to a current to-be-processed object, and combining the extracted binary group into a first set, wherein the binary group comprises subject words and modifiers; determining words of which term frequency-inverse document frequency (TF-IDF) is greater than a first preset threshold value in each comment, and combining the determined words into a second set; processing the first set and the second set according to a first preset rule to generate a third set; determining words of which a theme weight value is greater than a second preset threshold value in each comment, and combining the determined words of which the theme weight value is greater than the second preset threshold value into a fourth set; intersecting a union set of the third set and the fourth set to obtain a fifth set; and performing duplication removal on words in the fifth set, and determining the residual words after duplication removal as comment tags of the current to-be-processed object.

To solve the problem above, an embodiment of the present disclosure discloses an electronic device, including at least one processor; and a memory communicably connected with the at least one processor for storing instructions executable by the at least one processor, wherein execution of the instructions by the at least one processor causes the at least one processor to: perform binary group extraction on each comment corresponding to a current to-be-processed object, and combining the extracted binary group into a first set, wherein the binary group comprises subject words and modifiers; determine words of which term frequency-inverse document frequency is greater than a first preset threshold value in each comment, and combining the determined words into a second set, process the first set and the second set according to a first preset rule to generate a third set; determine words of which a theme weight value is greater than a second preset threshold value in each comment, and combining the determined words of which the theme weight value is greater than the second preset threshold value into a fourth set; intersect the union set of the third set and the fourth set to obtain a fifth set; perform duplication removal on words in the fifth set, and determining the residual words after duplication removal as comment tags of the current to-be-processed object.

An embodiment of the present disclosure discloses a computer program, including computer readable codes, wherein the method for comment tag extraction above is executed by an electronic device when the computer readable codes are operated on the electronic device.

An embodiment of the present disclosure discloses anon-transitory computer-readable medium storing therein executable instructions that, when executed by an electronic device, cause the electronic device to perform operations including: performing binary group extraction on each comment corresponding to a current to-be-processed object, and combine the extracted binary group into a first set, wherein the binary group comprises subject words and modifiers; determining words of which term frequency-inverse document frequency is greater than a first preset threshold value in each comment, and combining the determined words into a second set; processing the first set and the second set according to a first preset rule to generate a third set; determining words of which a theme weight value is greater than a second preset threshold value in each comment, and combining the determined words of which the theme weight value is greater than the second preset threshold value into a fourth set; intersecting a union set of the third set and the fourth set to obtain a fifth set; performing duplication removal on words in the fifth set, and determining the residual words after duplication removal as comment tags of the current to-be-processed object.

### BRIEF DESCRIPTION OF THE DRAWINGS

To clearly describe the technical schemes in the embodiments of the present disclosure or in the prior art, figures need to be used in the description of the embodiments or the prior art are briefly introduced as follows, obviously, the figures described below are some embodiments of the present disclosure, and for a person skilled in the art, other figures can be also obtained according to the figures under the condition that no creative work is made.

FIG. 1 is a flow chart of a method for comment tag extraction according to some embodiments of the present disclosure.

FIG. 2 is a flow chart of the method for comment tag extraction according to some embodiments of the present disclosure.

FIG. 3 is a flow chart of performing comment tag extraction by adopting the method shown in some embodiments of the present disclosure.

FIG. 4 is a probability diagram of an LDA model.

FIG. 5 is a structure diagram of the device for comment tag extraction according to some embodiments of the present disclosure.

FIG. 6 is a the structure diagram of the device for comment tag extraction according to some embodiments of the present disclosure.

FIG. 7 is a block diagram of an electronic device used for executing the method according to some embodiments of the present disclosure.

FIG. 8 is a storage unit used for keeping or carrying program codes realizing the method according to some embodiments of the present disclosure.

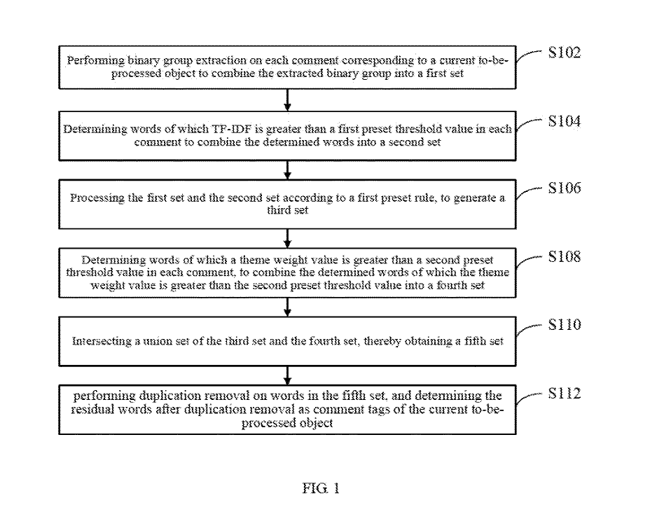

### DETAILED DESCRIPTION

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by a person skilled in the art under the condition that no creative work is made all belong to the protection scope of the present disclosure.

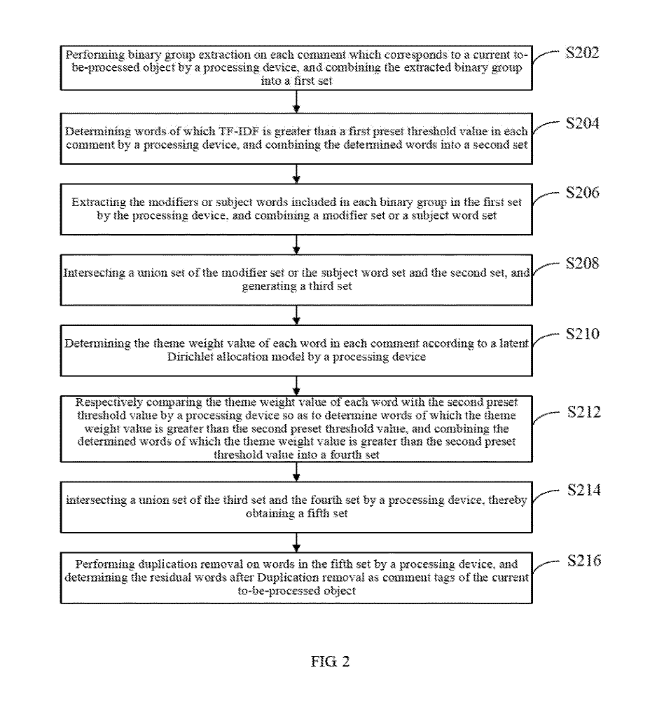

FIG. 2 shows the flow chart of the steps of the method for comment tag extraction in some embodiments of the present disclosure.

The method for comment tag extraction in the embodiment of the present disclosure includes the steps as follows.

In step S102, an binary group extraction is performed on each comment which corresponds to a current to-be-processed object, to combine the extracted binary group into a first set.

Wherein the to-be-processed object can be songs, films, items, etc., and each comment, which corresponds to the current to-be-processed object, refers to each comment of the object. For example, when comment tags need to be extracted from many comments of a film, the film is the to-be-processed object, and total comments aiming at the film are various comments, which correspond to the current to-be-processed object.

The binary group includes subject words and modifiers. For example, the binary group is (song, classic). Words and grammars constructing sentences in each comment are analyzed, a binary group included in each comment is obtained, and binary groups of the comments are combined into a first set.

In step S104: words of which TF-IDF is greater than a first preset threshold value in each comment are determined, to combine the determined words into a second set;

Its important to note that determination of TF-IDF (term frequency-inverse document frequency) of words in the comment refers to the related technology, and specific limitation is not made in the embodiment of the present disclosure.

The first preset threshold value can be set in the specific implementation process by a person skilled in the art according to actual requirements, and specific limitation is not made in the embodiment of the present disclosure.

In step S106: the first set and the second set are processed according to a first preset rule, to generate a third set.

The person skilled in the art can set the first preset rule according to actual requirements, and specific limitation is not made in the embodiment of the present disclosure. For example, the first preset rule is set into a set of forming subject words by extracting each subject word group from the first set, and the subject word set and the second set are subjected to union set operation. For example, the first preset rule is set into a set of forming modifiers by extracting each modifier word group from the first set, and the modifier set and the second set are subjected to union set operation. For another example, the first preset rule is set to perform union set operation on the first set and the second set.

In step S108: words of which a theme weight value is greater than a second preset threshold value in each comment are determined, to combine the determined words of which the theme weight value is greater than the second preset threshold value into a fourth set.

Wherein, the person skilled in the art can set the second preset threshold value according to actual requirements, and specific limitation is not made in the embodiment of the present disclosure.

In step S110: a union set of the third set and the fourth set is intersected, to obtain a fifth set.

The operation of intersecting the union set refers to forming a novel set by extracting the same element in the two sets. For example, the third set includes words A and B, the fourth set includes words A and C, and when the union set is obtained from intersecting the two sets, the words A are extracted to form the fifth set.

In step S112: duplication removal on words in the fifth set is performed, to determine the residual words after duplication removal as comment tags of the current to-be-processed object.

According to the method for comment tag extraction provided by the embodiment of the present disclosure, each sentence in each comment is subjected to word and syntax analysis so as to construct a binary group of words, independent meaningless noise words can be filtered by effectively utilizing the relation of context of words in the comment, and the tag accuracy is correspondingly improved. In addition, according to the method for comment tag extraction and device provided by the present disclosure, when words serving as candidate comment tags are screened, theme weight values of the words are screened, words of which the theme weight value is smaller than or equal to a second preset threshold value are filtered, words with close relation to the theme of comments are remained, and the accuracy of the extracted tags can be further improved.

FIG. 2 shows the flow chart of the steps of the method for comment tag extraction according to some embodiments of the present disclosure.

The method for comment tag extraction in the embodiment of the present disclosure specifically includes the following steps: In step S202: binary group extraction on each comment, which corresponds to a current to-be-processed object is performed by a processing device to combine the extracted binary group into a first set.

Wherein, the processing device can be any device with a computing function, such as a server, a computer, etc. The binary group includes subject words and modifiers.

An optional manner of performing binary group extraction on each comment, which corresponds to the current to-be-processed object, is as follows:

performing word segmentation on each sentence contained in each comment aiming at the comment, and determining word characteristic of each word subjected to word segmentation; and performing grammar analysis on the word characteristic of each word, acquiring a modificatory relationship among the words in each sentence, and constructing a binary group which corresponds to each sentence according to the modificatory relationship. Each comment is processed by adopting the previous extraction manner, namely all the binary groups can be determined.

For example, when a sentence included in the current comment is “songs of Wang Feng are classic, and lyrics are inspirational”, the binary group determined after word segmentation of sentence, word characteristic determination and grammar analysis is (songs, classic), (lyrics, inspirational).

In step S204, words of which TF-IDF is greater than a first preset threshold value in each comment is determined by a processing device to combine the determined words into a second set.

The TF-IDF of the words is a product of TF (term frequency) and IDF (inverse document frequency) of words.

Wherein, person skilled in the art can set the specific calculation mode of TF according to actual requirements. For example, the TF of words can be calculated by adopting the following formula of TF=frequency of words appearing in the same comment/total word number of the comment in which the words are positioned. The TF of the words also can be determined by adopting the following formula of TF=frequency of words appearing in a comment.

A person skilled in the art also can set the specific calculation mode of IDF according to actual requirements. For example, the IDF of words can be calculated by adopting the following formula of IDF=log (total number of comments under the to-be-processed object/(number of comments including the words+1)). The IDF of the words also can be calculated by adopting the following formula of IDF=log (total number of comments under the to-be-processed object/the number of comments including the words).

Optionally, the first preset threshold value is 0.75. Certainly, not limited to the value, the first preset threshold value also can be 0.7, 0.8, etc. In the specific implementation process, the first preset threshold value can be set into any proper value by a person skilled in the art according to actual requirements.

After the TF-IDF of each word is determined, the TF-IDF of each word and the first preset threshold value are respectively compared, so that words of which the TF-IDF is greater than the first preset threshold value and the words are combined into a second set.

In step S206: the modifiers or subject words included in each binary group in the first set are extracted by the processing device to combine a modifier set or a subject word set.

The first set includes a plurality of binary group, and each binary group includes a modifier and a subject word. In the step, the modifier included in each binary group needs to be extracted, and the extracted modifiers are combined into a modifier set. For example, the first set includes binary groups (songs, classic), (lyrics, inspirational), the extracted modifiers are “classic” and “inspirational”, and the “classic” and “inspirational” are combined into the modifier set. Certainly, the subject words included in the binary groups also can be extracted, and the extracted subject words are combined into a subject word set.

In step S208: the modifier set or the subject word set and the second set are unified, to generate a third set.

For example, if the modifier set includes words A, B and C, and the second set includes words A, D and E, the third set generated by unifying the two sets includes the words A, B, C, D and E.

In step S210: the theme weight value of each word in each comment according to a latent Dirichlet allocation model is determined by a processing device.

Theme influence, namely the theme weight value, of a word in a document can be calculated by the latent Dirichlet allocation (Latent Dirichlet Allocation) model. The specific determination mode can refer to the related technology, and specific limitation is not made in the embodiment of the present disclosure. Correspondingly, each comment serves as a document, and the theme weight value of the words in all the comments can be determined.

In step S212: the theme weight value of each word with the second preset threshold value is respectively compared by a processing device so as to determine words of which the theme weight value is greater than the second preset threshold value, to combine the determined words of which the theme weight value is greater than the second preset threshold value into a fourth set.

It is important to note that a person skilled in the art can set the second preset threshold value according to actual requirements. Optionally, the second preset threshold value is set to be 0.8. Certainly, not limited to the value, the second preset threshold value also can be 0.7, 0.75, 0.85, etc.

In the step, words of which the theme weight value is smaller than or equal to the second preset threshold value can be filtered, words with close relation to the theme of comments are remained, and the accuracy of the extracted tags can be improved.

In step S214: a union set of the third set and the fourth set is intersected by a processing device, thereby obtaining a fifth set.

In step S216: duplication removal on words in the fifth set is performed by a processing device, to determine the residual words after duplication removal as comment tags of the current to-be-processed object.

An optional manner of performing duplication removal on the words in the fifth set is as follows.

In S1: every two of the words in the fifth set are respectively combined, and word groups are combined.

For example, if the fifth set includes words A, B, C and D, words A and B, A and C, A and D, B and C, B and D and C and D are combined into multiple word groups respectively.

In S2: a similarity value of two words in the current word group is respectively determined according to the minimum editing distance and word characteristic similarity of two words in the current word group aiming at each word group.

An optional manner of determining the similarity value of two words in the current word group according to the minimum editing distance and word characteristic similarity of the two words is calculated by adopting the following formula:

P(S,T)=α(D(S,T)+1)+βSim(pos);

wherein, S and T represent two words in the word group, P(S,T) represents the similarity of the two words, D(S,T) represents the minimum editing distance of the two words, Sim (pos) represents word characteristic similarity of the two words, and both α and β are weight coefficients. If S and T have the same word characteristic, Sim (pos) is 1, and if S and T have different word characteristics, Sim (pos) is 0, α+β=1, P(S, T)ε[0,1].

When D(S,T)=0 and Sim (pos)=1, that is, words S and T are in the minimum editing distance of 0 and have the same word characteristic, P(S, T)=1, and the similarity of S and T is the maximum. Sim(pos)=0, the larger the D(S,T) is, the larger the minimum editing distance of the words S and T is; the smaller the P (S,T) is, the smaller similarity of S and T is.

Optionally, α can be set to be 0.6, and β is set to be 0.4.

In S3: one word in a word group of which the similarity value is greater than a third set threshold value is respectively deleted so as to finish duplication removal of the fifth set.

For example, if the similarity value of the word group composed of S and T is greater than the third set threshold value, any one of the words S and T needs to be deleted from the fifth set; and if the similarity value of the word group composed of S and T is smaller than or equal to the third set threshold value, word deletion does not need to be performed. By adopting the same principle, each word group is processed, and duplication removal of the fifth set can be finished.

According to the method for comment tag extraction provided by the embodiment of the present disclosure, each sentence in each comment is subjected to word and syntax analysis so as to construct a binary group of words, independent meaningless noise words can be filtered by effectively utilizing the relation of context of words in the comment, and the tag accuracy is correspondingly improved. In addition, according to the method for comment tag extraction provided by the present disclosure, when words serving as candidate comment tags are screened, theme weight values of the words are screened, words of which the theme weight value is smaller than or equal to a second preset threshold value are filtered, words with close relation to the theme of comments are remained, and the accuracy of the extracted tags can be further improved.

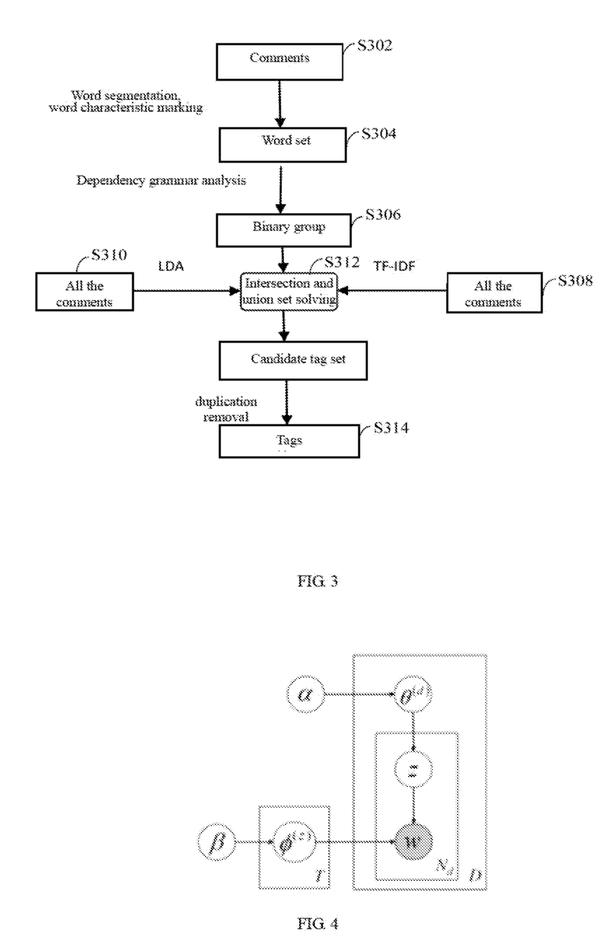

The FIG. 3 describes the method for comment tag extraction in the embodiment of the present disclosure by a specific example in the followings.

In the specific example, description is performed by taking a song as a to-be-processed object, and comment tags of the song are extracted. The specific extraction processes are as follows.

In step S302: a comment S which corresponds to the song is acquired.

Wherein, the song corresponds to multiple comments, and a comment S is pre-acquired for processing in the step.

In step S304: word segmentation and word characteristic marking on the sentence included in the acquired comment S are performed so as to extract a word set which corresponds to the comment S.

In order to extract structural relations among words in the comments, each sentence in each comment is subjected to word segmentation and word characteristic marking.

In step S306: dependency grammar analysis on the comment S is performed, and a binary group which corresponds to the comment S is determined.

In the step, each sentence is subjected to grammar analysis, modification among words is acquired, and finally the binary group is constructed. For example, if the comment is “songs of Wang Feng are classic, and lyrics are inspirational”, subject words and modifier words in the sentences can be obtained through dependency grammar analysis, a binary group constructed by (subject words, modifier words) is extracted to serve as a tag describing the song, and the extracted binary group is (songs, classic), (lyrics, inspirational).

The steps from S302 to S306 are cyclically executed until the binary groups in all the comments that correspond to the song are completely extracted. The extracted binary groups are combined into a candidate tag set A, namely a first set.

In step S308: TF-IDF calculation on words in all the comments which correspond to the song is performed, to generate a candidate tag set, namely a second set, according to the calculation result.

The higher the word's appearing frequency is, the more important the word to the song is, and the word appearing frequency in the specific example is calculated by TF statistics. However, for some comments, the higher the appearing frequency of a certain word is, the more unimportant the word to the song is. Therefore, a proper weight coefficient needs to be found to measure importance of the word. If a word is uncommon while often appears in the comments, the word reflects the characteristic of the song to a certain degree, namely the word can serve as a candidate tag. In order to solve the problem. IDF serves as a weight coefficient in the specific example.

Specifically, the two values, TF and IDF, of the word are multiplied so as to obtain a TF-IDF value of the word. The greater the TF-IDF value of the word is, the higher the importance of the word to the song is. In the specific example, the TF-IDF value of the word in all the comments which correspond to the song is calculated, one part of words which cannot meet requirements are screened by setting a threshold value, namely the first preset threshold value, and words meeting the requirements are constructed into a candidate tag set B, namely a second set.

Specific calculation steps of the TF-IDF aiming at a word are as what follows:

In step 1, TF is calculated.

Term frequency (TF)=frequency of words appearing in the comment/total word number of the comment.

Description: due to different lengths of the comments, the term frequency is standardized by dividing the total word number of the comment.

In step 2, IDF is calculated.

Inverse Document Frequency (IDF)=log (total number of comments corresponding to the song/(number of comments including the words+1)).

The more common a word is, the larger the denominator is, and the inverse document frequency is smaller and close to 0.

In step 2. TF-IDF is calculated.

TF-IDF=term frequency (TF)*inverse document frequency (IDF).

By repeating the previous calculation process, the TF-IDF of each word can be calculated.

In the embodiment of the present disclosure, a threshold value a, namely a first preset threshold value, is set, and the TF-IDF of the word is compared with the set threshold value, so that whether the word can be added into the candidate tag set B can be determined.

The threshold value a can be set to be 0.75, and each word is screened by the threshold value a. During screening, when the TF-IDF of the word >a, the word is added into the candidate tag set B.

In step S310: all the comments that correspond to the song are processed by using the LDA model to determine a candidate tag set D, namely a fourth set.

The LDA model is provided by Blei and other people in 2003 and is used for document theme modeling. In the LDA model, each document is expressed into mixed distribution containing K latent themes, each theme is multinomial distribution on W words, and the probability diagram expression of the model is shown as FIG. 4.

wherein, φ represents theme-word probability distribution in the LDA model, θ represents document-theme probability distribution, a and ft respectively represent hyper-parameters of Dirichlet prior distribution obeyed by θ and φ, hollow circle represents latent variable, solid circle represents observable variable, namely the word.

In the specific example, because the comments of the song are processed, all the comments which correspond to the song are equivalent to a to-be-processed document d, T(w|d) represents theme influence, namely the theme weight value, of the word in the document d, wherein, w represents the word in d, the document d is assumed to include t latent themes, and t is equal to 10 in the specific example. The higher the probability of the word w appearing in a theme z, the more important the word to the theme z is; if the higher the probability of the theme z which corresponds to w appearing in d is, the more important the theme z relative to the document d is; and therefore, w is more important. Based on the previous analysis, in the specific example, b_{w}^{z} represents the probability of the word w in the theme z, aₛ^{(d)} represents the probability of the theme z appearing in the document d, and the theme influence of the word w can be calculated through the following formula:

$$T ( w \vert d ) = {\sum }_{i = 1}^{t} ( {a}_{z = j}^{( d )} \times {b}_{w}^{z = i} ) \qquad ( 1 )$$

Wherein θ represents theme-theme distribution of the document, φ represents “theme-word” distribution of each theme, the two parameters are generally calculated through Gibbs sampling by utilizing conjugation property between Dirichlet distribution and multinomial distribution. The calculation formula is as follows:

$$\begin{matrix}{a}_{z = j}^{( d )} = \frac{{N}_{1} ( d , j )}{{\sum }_{k = 1}^{t} {N}_{1} ( d , k ) + t \times α} & ( 2 ) \\ {b}_{W}^{( z = j )} = \frac{{N}_{2} ( w , j )}{{\sum }_{k = 1}^{c} {N}_{2} ( k , j ) + N \times β} & ( 3 )\end{matrix}$$

Wherein, N₁(d, j) represents the frequency of words in the document d assigned to a theme j. N₂(w, j) represents the frequency of the word w assigned to the theme j in a training corpus, and N is total word number in the text. The formula (1) can be solved through the formula (2) and formula (3), so that the theme influence of a word in the document is calculated.

By repeating the previous formula, the theme influence of total words under all the comments that correspond to the song can be calculated.

In the specific embodiment, a threshold value, namely a second preset threshold value, is set, and T(w|d) of the word and the second preset threshold value are compared, so that whether the word can be added into the candidate tag set D, namely a fourth set, can be determined.

The second preset threshold value can be set to be 0.8, and each word can be screened by the second preset threshold value. During screening, when T(w|d) of the word >0.8, the word is added into the candidate tag set D.

It's important to note that the description above is performed by taking 0.8 as an example only, in the specific implementation process, the second preset threshold value can be set to be any proper value by a person skilled in the art, and specific limitation is not made in the specific example.

In step S312: intersection and union set processing are performed on each set determined in the steps 306, 308 and 310.

Specifically, the modifier in the candidate tag set A determined in the step S306 is extracted to record as a set Aₐ, performing union set operation on the set Aₐ and the candidate tag set B determined in the step S308, namely Aₐ∪B=C, thereby obtaining a candidate tag set C, namely a third set: and performing intersection solving operation on the candidate tag set C and the candidate tag set D, C∩D=E thereby obtaining a candidate tag set E, namely a fifth set.

In step S314: duplication removal is performed on the determined candidate tag set E, thereby obtaining words serving as comment tags finally.

In the specific example, the candidate tag set E is subjected to duplication removal by combining the word similarity of word characteristic based on the minimum editing distance. Specifically, the similarity of any two words S and T selected from the candidate tag set E is calculated by utilizing the following formula:

P(S,T)=α(D(S,T)+1)+βSim(pos)

wherein, S and T represent two words in the word group, P(S,T) represents the similarity of the two words, D(S,T) represents the minimum editing distance of the two words, Sim (pos) represents word characteristic similarity of the two words, and both α and β are weight coefficients. If S and T have the same word characteristic, Sim (pos) is 1, and if S and T have different word characteristics, Sim (pos) is 0, α+β=1, P(S, T)ε[0,1].

The minimum editing distance of the words S and T is 0 when D(S,T)=0 and Sim (pos)=1, P(S, T)=1, and the similarity of S and T is the maximum. When Sim (pos)=0, the larger the D (S,T) is, the larger the minimum editing distance of the words S and T is; the smaller the P (S,T) is, the smaller similarity of S and T is.

Optionally, the weight coefficient α is set to be 0.6, and the weight coefficient β is set to be 0.4.

The similarity of any two words in the candidate tag set E is respectively calculated through the previous formula. Then, words in the candidate tag set E are subjected to duplication removal according to the similarity.

When the similarity of two words in the candidate tag set E is greater than a third set threshold value (such as 0.7), the two words are considered to be repetitive, any one is deleted, all the words in the candidate tag set E are screened according to the method, and finally the residual word sets are taken as comment tags of the song.

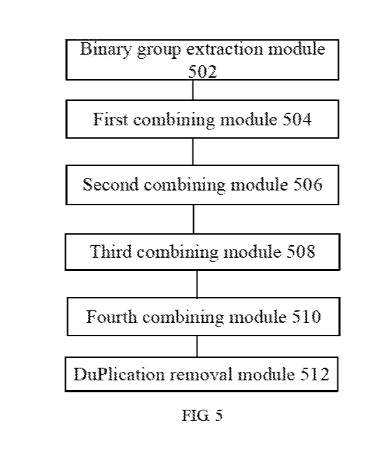

FIG. 5 shows the structure diagram of the device for comment tag extraction according to some embodiments of the present disclosure.

The device for comment tag extraction in the embodiment of the present disclosure includes: a binary group extracting module 502, used for performing binary group extraction on each comment which corresponds to a current to-be-processed object, and combining the extracted binary group into a first set, wherein the binary group includes subject words and modifiers; a first combining module 504, used for determining words of which Term Frequency-Inverse Document Frequency TF-IDF is greater than a first preset threshold value in each comment, and combining the determined words into a second set: a second combining module 506, used for processing the first set and the second set according to a first preset rule, and generating a third set; a third combining module 508, used for determining words of which a theme weight value is greater than a second preset threshold value in each comment, and combining the determined words of which the theme weight value is greater than the second preset threshold value into a fourth set; a fourth combining module 510, used for intersecting the union set of the third set and the fourth set, thereby obtaining a fifth set; and a duplication removal module 512, used for performing duplication removal on words in the fifth set, and determining the residual words after duplication removal as comment tags of the current to-be-processed object.

According to the device for comment tag extraction provided by the embodiment of the present disclosure, each sentence in each comment is subjected to word and syntax analysis so as to construct a binary group of words, independent meaningless noise words can be filtered by effectively utilizing the relation of context of words in the comment, and the tag accuracy is correspondingly improved. In addition, according to the device for comment tag extraction provided by the present disclosure, when words serving as candidate comment tags are screened, theme weight values of the words are screened, words of which the theme weight value is smaller than or equal to a second preset threshold value are filtered, words with close relation to the theme of comments are remained, and the accuracy of the extracted tags can be further improved.

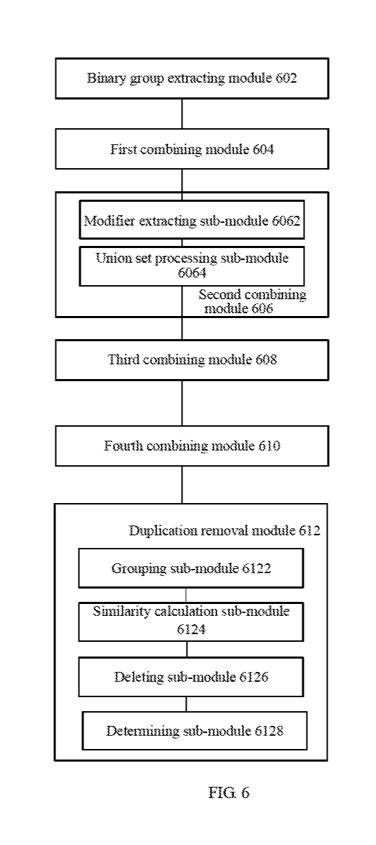

FIG. 6 shows the structure diagram of the device for comment tag extraction according to some embodiments of the present disclosure.

The device for comment tag extraction in the embodiment of the present disclosure is further optimized by the device for comment tag extraction shown in the embodiment, and the optimized device for comment tag extraction includes: a binary group extracting module 602, used for performing binary group extraction on each comment which corresponds to a current to-be-processed object, and combining the extracted binary group into a first set, wherein the binary group includes subject words and modifiers; a first combining module 604, used for determining words of which Term Frequency-Inverse Document Frequency TF-IDF is greater than a first preset threshold value in each comment, and combining the determined words into a second set; a second combining module 606, used for processing the first set and the second set according to a first preset rule, and generating a third set; a third combining module 608, used for determining words of which a theme weight value is greater than a second preset threshold value in each comment, and combining the determined words of which the theme weight value is greater than the second preset threshold value into a fourth set; a fourth combining module 610, used for intersecting the union set of the third set and the fourth set, thereby obtaining a fifth set; and a duplication removal module 612, used for performing duplication removal on words in the fifth set, and determining the residual words after duplication removal as comment tags of the current to-be-processed object.

Optionally, when the binary group extracting module 602 performs binary group extraction on each comment which corresponds to the current to-be-processed object: performing word segmentation on each sentence contained in each comment aiming at the comment, and determining word characteristic of each word subjected to word segmentation; and performing grammar analysis on the word characteristic of each word, acquiring a modificatory relationship among the words in each sentence, and constructing a binary group which corresponds to each sentence according to the modificatory relationship.

Optionally, the second combining module 606 includes: a modifier extracting sub-module 6062, used for extracting modifiers or subject words contained in each binary group in the first set, and combining a modifier set or a subject word set; and a union set processing sub-module 6064, used for unifying the modifier set or the subject word set and the second set, and generating the third set.

Optionally, when the third combining module 608 determines the words of which the theme weight value is greater than the second preset threshold value in each comment, determining the theme weight value of each word in each comment according to a latent Dirichlet allocation model; and respectively comparing the theme weight value of each word with the second preset threshold value so as to determine words of which the theme weight value is greater than the second preset threshold value.

Optionally, the duplication removal module 612 includes: a grouping sub-module 6122, used for respectively combining every two words in the fifth set, and combining word groups; a similarity calculation sub-module 6124, used for respectively determining a similarity value of two words in the current word group according to the minimum editing distance and word characteristic similarity of two words in the current word group aiming at each word group; a deleting sub-module 6126, used for respectively deleting one word in a word group of which the similarity value is greater than a third set threshold value so as to finish duplication removal of the fifth set; and a determining sub-module 6128, used for determining residual words after duplication removal as comment tags of the current to-be-processed object.

Optionally, the similarity calculation sub-module 6124 is used for calculating the similarity of two words in each word group by utilizing the following formula: P(S, T)=α(D(S,T)+1)+βSim (pos); wherein, S and T represent two words in the word group, P(S,T) represents the similarity of the two words, D(S,T) represents the minimum editing distance of the two words, Sim (pos) represents word characteristic similarity of the two words, and both α and β are weight coefficients.

The device for comment tag extraction in the embodiment of the present disclosure is used for realizing the corresponding method for comment tag extraction in the previous embodiments, and has beneficial effects corresponding to the embodiments of the method, and unnecessary details are avoided.

Embodiments in the specification are described in a progressive manner, emphasized description of each embodiment is difference from other embodiments, and the same and similar parts among the embodiments can refer to one another. Because the embodiments of the system are basically similar to the embodiments of the method, the description is relatively simple, and the related part can refer to the embodiments of the method.

The embodiments of the device described above are only schematic, a unit, which can be described as a separated part can be or not physically separated, a member for unit display can be or not a physical unit, that is, the member can be located at one place or distributed to multiple network units. A part of or all modules can be selected to achieve the purposes of the schemes of the embodiments according to practical demands. The present disclosure can be understood and implemented by a person skilled in the art without creative work.

According to description of the embodiments above, a person skilled in the art can clearly know that each embodiment can be realized in a manner of software plus necessary general hardware platform and can be realized by virtue of hardware certainly. Based on the understanding, the technical scheme or a part making contribution to the prior art can be essentially reflected in a software product form, and the computer software products can be stored in computer readable media, such as ROM/RAM, disks, compact discs, etc., and include a plurality of instructions to be used for enabling computer equipment (also can be a personal computer, a server or network equipment, etc.) to execute the method in each embodiment or in a certain part of the embodiment.

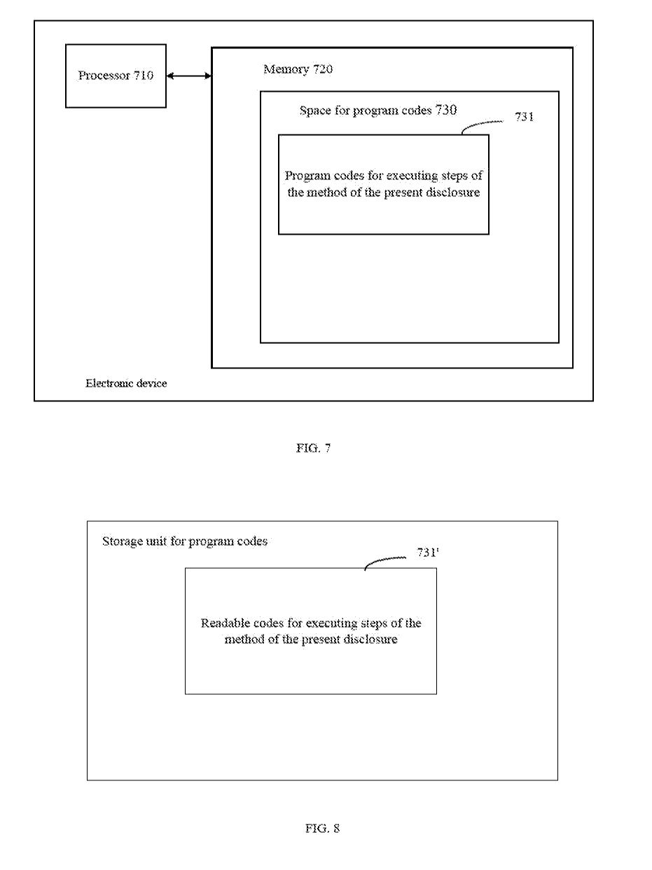

For example, FIG. 7 illustrates a block diagram of an electronic device for executing the method according the disclosure. Traditionally, the electronic device includes a processor 710 and a computer program product or a computer readable medium in form of a memory 720. The memory 720 could be electronic memories such as flash memory, EEPROM (Electrically Erasable Programmable Read-Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the electronic device as shown in FIG. 7. The program codes may be compressed for example in an appropriate form. Usually, the memory cell includes computer readable codes 731′ which can be read for example by processors 710. When these codes are operated on the electronic device, the electronic device may execute respective steps in the method as described above.

The final description is that the embodiments are only used for describing the technical scheme of the present disclosure but not for limiting. Although the present disclosure is specifically described with reference to the embodiments, a person skilled in the art shall understand that the technical scheme recorded by each of the embodiments can be modified, or one part of technical characteristics can be equivalently replaced; and the modification or replacement does not enable the essence of the corresponding technical scheme to get out of the spirit and scope of the technical scheme in each embodiment of the present disclosure.

What is claimed is:

1. A method for comment tag extraction, comprising:
performing binary group extraction on each comment corresponding to a current to-be-processed object, and combining the extracted binary group into a first set, wherein the binary group comprises subject words and modifiers;
determining words of which term frequency-inverse document frequency (TF-IDF) is greater than a first preset threshold value in each comment, and combining the determined words into a second set;
processing the first set and the second set according to a first preset rule to generate a third set;
determining words of which a theme weight value is greater than a second preset threshold value in each comment, and combining the determined words of which the theme weight value is greater than the second preset threshold value into a fourth set;
intersecting a union set of the third set and the fourth set to obtain a fifth set; and
performing duplication removal on words in the fifth set, and determining the residual words after duplication removal as comment tags of the current to-be-processed object.

2. The method according to the claim 1, wherein the performing binary group extraction on each comment which corresponds to the current to-be-processed object comprises:
for each comment, performing word segmentation on each sentence included in the comment, and determining word characteristic of each word after word segmentation; and
performing grammar analysis on the word characteristic of each word, acquiring a modificatory relationship among the words in each sentence, and constructing a binary group which corresponds to each sentence according to the modificatory relationship.

3. The method according to the claim 1, wherein the processing the first set and the second set according to the first preset rule and generating the third set comprises:
extracting modifiers or subject words included in each binary group in the first set to combine a modifier set or a subject word set; and
unifying the modifier set or the subject word set and the second set to generate the third set.

4. The method according to the claim 1, wherein the determining words of which the theme weight value is greater than the second preset threshold value in each comment comprises:
determining the theme weight value of each word in each comment according to a latent Dirichlet allocation model; and
respectively comparing the theme weight value of each word with the second preset threshold value to determine words of which the theme weight value is greater than the second preset threshold value.

5. The method according to the claim 1, wherein the performing duplication removal on words in the fifth set comprises:
respectively combining every two words in the fifth set to form word groups;
for each word group, respectively determining a similarity value of two words in the current word group according to the minimum editing distance and word characteristic similarity of two words in the current word group; and
deleting one word in the word group of which the similarity value is greater than a third set threshold value to finish duplication removal of the fifth set.

6. The method according to the claim 5, wherein the similarity of two words in each word group is calculated by utilizing the following formula:
P(S,T)=α(D(S,T)+1)+βSim(pos);
wherein S and T represent two words in the word group, P(S,T) represents the similarity of the two words, D(S,T) represents the minimum editing distance of the two words, Sim (pos) represents word characteristic similarity of the two words, and both α and β are weight coefficients.

7. An electronic device, comprising:
at least one processor; and
a memory communicably connected with the at least one processor for storing instructions executable by the at least one processor, wherein execution of the instructions by the at least one processor causes the at least one processor to:
perform binary group extraction on each comment corresponding to a current to-be-processed object, and combining the extracted binary group into a first set, wherein the binary group comprises subject words and modifiers;
determine words of which term frequency-inverse document frequency is greater than a first preset threshold value in each comment, and combining the determined words into a second set;
process the first set and the second set according to a first preset rule to generate a third set;
determine words of which a theme weight value is greater than a second preset threshold value in each comment, and combining the determined words of which the theme weight value is greater than the second preset threshold value into a fourth set;
intersect the union set of the third set and the fourth set to obtain a fifth set;
perform duplication removal on words in the fifth set, and determining the residual words after duplication removal as comment tags of the current to-be-processed object.

8. The electronic device according to the claim 7, wherein the step to perform binary group extraction on each comment which corresponds to the current to-be-processed object comprises:
for each comment, performing word segmentation on each sentence included in the comment, and determining the word characteristic of each word after word segmentation, and perform grammar analysis on the word characteristic of each word, acquiring a modificatory relationship among the words in each sentence, and constructing a binary group which corresponds to each sentence according to the modificatory relationship.

9. The electronic device according to the claim 7, wherein the step to process the first set and the second set according to a first preset rule and generating a third set comprises:
extracting modifiers or subject words included in each binary group in the first set to combine a modifier set or a subject word set;
unifying the modifier set or the subject word set and the second set to generate the third set.

10. The electronic device according to the claim 7, wherein the step to determine words of which the theme weight value is greater than the second preset threshold value in each comment comprises:
determining the theme weight value of each word in each comment according to a latent Dirichlet allocation model; and respectively comparing the theme weight value of each word with the second preset threshold value to determine words of which the theme weight value is greater than the second preset threshold value.

11. The electronic device according to the claim 7, wherein the step to perform duplication removal on words in the fifth set comprises:
respectively combining every two words in the fifth set to form word groups;
for each word group, respectively determining a similarity value of two words in the current word group according to the minimum editing distance and word characteristic similarity of two words in the current word group;
deleting one word in the word group of which the similarity value is greater than a third set threshold value to finish duplication removal of the fifth set;
determining residual words after duplication removal as comment tags of the current to-be-processed object.

12. The electronic device according to the claim 11, wherein the similarity of two words in each word group is calculated by utilizing the following formula:
P(S,T)=α(D(S,T)+1)+βSim(pos);
wherein, S and T represent two words in the word group, P(S,T) represents the similarity of the two words, D(S,T) represents the minimum editing distance of the two words, Sim (pos) represents word characteristic similarity of the two words, and both α and β are weight coefficients.

13. A non-transitory computer-readable storage medium storing therein executable instructions that, when executed by an electronic device, cause the electronic device to perform operations comprising:
performing binary group extraction on each comment corresponding to a current to-be-processed object, and combine the extracted binary group into a first set, wherein the binary group comprises subject words and modifiers;
determining words of which term frequency-inverse document frequency is greater than a first preset threshold value in each comment, and combining the determined words into a second set;
processing the first set and the second set according to a first preset rule to generate a third set;
determining words of which a theme weight value is greater than a second preset threshold value in each comment, and combining the determined words of which the theme weight value is greater than the second preset threshold value into a fourth set;
intersecting a union set of the third set and the fourth set to obtain a fifth set;
performing duplication removal on words in the fifth set, and determining the residual words after duplication removal as comment tags of the current to-be-processed object.

14. The non-transitory computer-readable storage medium according to the claim 13, wherein the performing binary group extraction on each comment which corresponds to the current to-be-processed object comprises:
for each comment, performing word segmentation on each sentence included in the comment, and determining word characteristic of each word after word segmentation; and
performing grammar analysis on the word characteristic of each word, acquiring a modificatory relationship among the words in each sentence, and constructing a binary group which corresponds to each sentence according to the modificatory relationship.

15. The non-transitory computer-readable storage medium according to the claim 13, wherein the processing the first set and the second set according to the first preset rule and generating the third set comprises:
extracting modifiers or subject words included in each binary group in the first set to combine a modifier set or a subject word set; and
unifying the modifier set or the subject word set and the second set to generate the third set.

16. The non-transitory computer-readable storage medium according to the claim 13, wherein the determining words of which the theme weight value is greater than the second preset threshold value in each comment comprises:
determining the theme weight value of each word in each comment according to a latent Dirichlet allocation model; and
respectively comparing the theme weight value of each word with the second preset threshold value to determine words of which the theme weight value is greater than the second preset threshold value.

17. The non-transitory computer-readable storage medium according to the claim 13, wherein the performing duplication removal on words in the fifth set comprises:
respectively combining every two words in the fifth set to form word groups;
for each word group, respectively determining a similarity value of two words in the current word group according to the minimum editing distance and word characteristic similarity of two words in the current word group; and
deleting one word in the word group of which the similarity value is greater than a third set threshold value to finish duplication removal of the fifth set.

18. The non-transitory computer-readable storage medium according to the claim 17, wherein the similarity of two words in each word group is calculated by utilizing the following formula:
P(S,T)=α(D(S,T)+1)+βSim(pos);
wherein S and T represent two words in the word group, P(S,T) represents the similarity of the two words, D(S,T) represents the minimum editing distance of the two words, Sim (pos) represents word characteristic similarity of the two words, and both α and β are weight coefficients.
